(19) United States
(12) Patent Application Publication
(10) Pub. No.: US 2022/0184778 A1
(43) Pub. Date: Jun. 16, 2022

(54) MODULAR MULTIPLE-USE TOOL

(71) Applicant: Robin Peng, Sandy, UT (US)

(72) Inventor: Robin Peng, Sandy, UT (US)

(21) Appl. No.: 17/599,663

(22) PCT Filed: Mar. 30, 2020
(86) PCT No.: PCT/US20/25827

§ 371 Date: Sep. 29, 2021

Related U.S. Application Data
(60) Provisional application No. 62/826,593, filed on Mar. 29, 2019.

(51) Int. Cl. B25B 13/58; B25B 13/14; B25G 1/08

(52) U.S. Cl. CPC B25B 13/58; B25G 1/085; B25B 13/14

(57) ABSTRACT

A modular tool with improved tool interface structures may feature an adjustable wrench body (110) with tool modules (120) which fit within the jaws (114, 116) of the head of the tool. The tool body (110) (120) that serve as tools or as attachment for tool components, like tool bits or sockets. The tool features a ratcheting engagement of the jaws (162, 172) with a quick release (117) and spring bias (176) that allows for easy attachment of the modules.

### CROSS-REFERENCES TO RELATED APPLICATIONS

This application claims priority under 35 USC § 371 as a national phase application of prior filed PCT Application number PCT/US2020/025827, which in turn claims the benefit of priority under Article 8 of the Patent Cooperation Treaty, as defined by Rule 80.5, to U.S. Provisional Application 62/826,593, filed Friday, Mar. 29, 2019, and incorporates these prior applications by reference herein in their entirety.

### FIELD OF THE INVENTION

The present invention relates to the field of hand tools and more particularly relates to a hand tool with multiple attachable and detachable tool head modules and a connection system which holds a selected module in place on the tool.

### BACKGROUND OF THE INVENTION

The concept of having a single tool that performs a variety of functions is an old one. Historically, pocketknives, can-openers and eating utensils were incorporated into a single unit as an early survival tool. Multi-purpose tools were later introduced catering to outdoor recreational activities and garage handyman alike. The most classic example of a multiple purpose tool in the modern era is perhaps the SWISS ARMY KNIFE by VICTORINOX. This knife has a reputation for having multiple tools contained in the small profile of a single pocketknife. In so doing, a user may have a perfect tool for any job he or she may encounter. However, the tools in the knife must fit within the confines of the tool handle. As such, the expense of versatility comes at the price of sacrificing functionality and sound ergonomics, limiting the effectiveness of the tools as a whole and limits the type of tools that may be incorporated into the knife profile.

A modular tool is an improved concept where a single base serves as a platform on which any number of tools may be mounted for use. However, any modular tool has a rich background art in which to survive. A simple ratcheting socket wrench or a chucked drill would be a good example of this strategy as both the wrench body and the drill may receive different tools, which may or not be socket heads or drill bits, as the user needs. Today, many living and activity scenarios require a premium be put on both space and encumbrance. As such, a having full tool set may be an impractical or even impossible goal, especially given that such tools would be kept in case of basic maintenance or emergency use—hardly an everyday occurrence. Such tools must be compact, easy to store, easy to add necessary modules, effective in use, and durable, among other requirements. Modularity would be increased if the tool could also accommodate multiple styles of tool mounting strategies, such as a socket wrench mount and a drill chuck. Such tools could be used in small apartments, college dormitories, and other locations and situations where a user may not have great need of more established tool sets.

The modern adjustable wrench, or spanner, is over 100 years old and has not seen much improvement. To this point, there has been no attempt to add functionality to the adjustable wrench. The present invention creates a new product category where a modular multi-use tool features an adjustable wrench as its base tool and incorporates different individual tool modules to provide diverse mounting structures for different tool attachments. A latching system may keep the various tool modules in position during use. The present invention represents a departure from the prior art and gains maximum tool effectiveness because the modular tool of the present invention allows for the accommodation of different tools which utilize different mounting strategies. The multi-tool provides an ergonomic, light-weight tool which is compact and adaptable to multiple situations, tasks, and environments.

### SUMMARY OF THE INVENTION

In view of the foregoing disadvantages inherent in the known types of modular tools, an improved modular tool may provide a uniform base tool for use with many different types of tool, a modular tool that meets the following objectives

As such, a new and improved modular tool may comprise a head constructed as a adjustable wrench with a plurality of modules to fit within and about the jaws of said adjustable wrench and accommodate multiple tool attachments in order to accomplish these objectives. The preferred embodiment features a ratcheting moving jaw with a quick release lever.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of one embodiment of a modular tool.

FIG. 2 is an exploded view of the modular tool of FIG. 1

FIG. 3 is an alternate perspective view of the modular tool of FIG. 1.

FIG. 4 is an alternate exploded view of the modular tool of FIG. 1.

FIG. 5 is a perspective view of the attachment module of the modular tool of FIG. 1.

FIG. 6 is an alternate perspective view of the attachment module of the modular tool of FIG. 1.

FIG. 7 is a top plan view of the modular tool of FIG. 1, the tool attachment module being removed.

FIG. 8 is a close-up view of the head of the modular tool of FIG. 1.

FIG. 9 is a side elevational of modular tool of FIG. 9, taken along line X-X.

FIG. 11 is a top plan view of the modular tool of FIG. 1.

FIG. 12 is a sectional view of modular tool of FIG. 11, taken along line XII-XII.

FIG. 13 is a sectional view of modular tool of FIG. 11, taken along line XIII-XIII.

FIG. 14 is a perspective view of the modular tool of FIG. 1, having its release button actuated.

FIG. 15 is a rear perspective view of the modular tool of FIG. 14, after release button actuation.

FIG. 16 is a rear perspective view of the modular tool of FIG. 1, with a bit connector.

FIG. 17 is an alternate perspective view of the modular tool of FIG. 16, in use with optional tool bits.

FIG. 18 is a perspective view of the modular tool of FIG. 1, the hammer head being removed.

### DETAILED DESCRIPTION OF THE PREFERRED EMBODIMENT

With reference now to the drawings, preferred embodiments of the modular tool are herein described. It should be noted that the articles “a”, “an”, and “the”, as used in this specification, include plural referents unless the content clearly dictates otherwise.

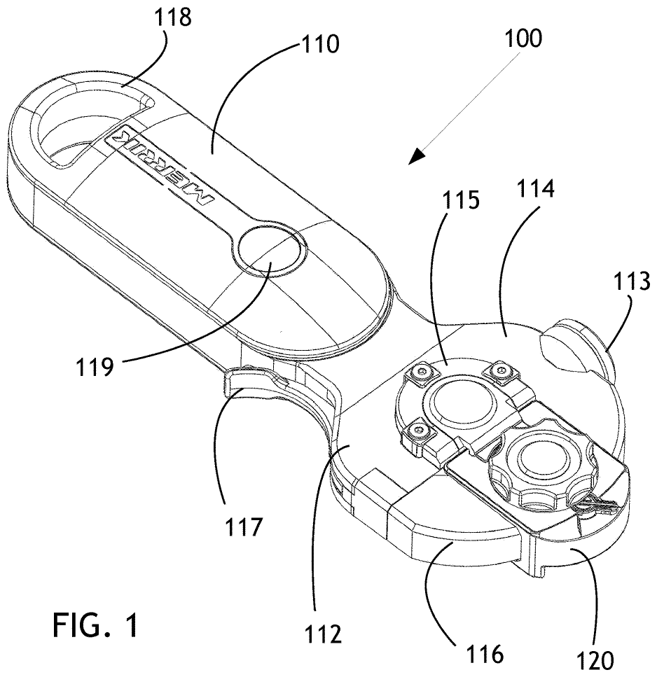

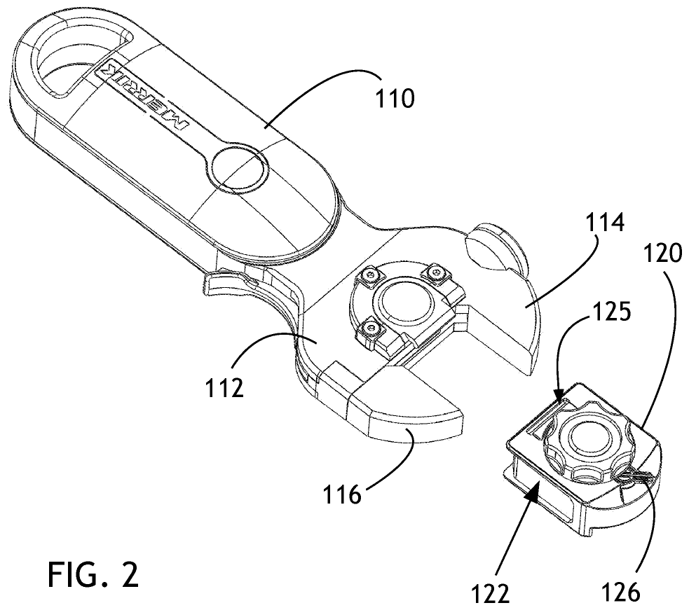

With reference to FIG. 1-2, the depicted tool 100 features an adjustable wrench as its base (110). This wrench (110) may present rule markings, a level, or other static tools to add utility. A loop (118) may be provided to aid in hanging the tool on a belt, peg board, or other convenient system. The head of the tool (112) features both static (maxilla) (114) and movable (mandible) (116) jaws. Additional functionality is afforded by various attachment modules (120) which fit within the open jaws of the tool head (112). In use, the jaws (114, 116) should be at their maximum distance apart wₘ (FIG. 7) when setting any module within, as an accidental expansion of the jaws could cause the attachment module (120) to slip. The sides and rear of attachment module (120) should have a specially shaped trough (122) which keys into the jaws (114, 116) and the bottom of the opening between said jaws when module (120) is in place therebetween. This then helps lock the attachment module (120) in place relative to the tool head (112).

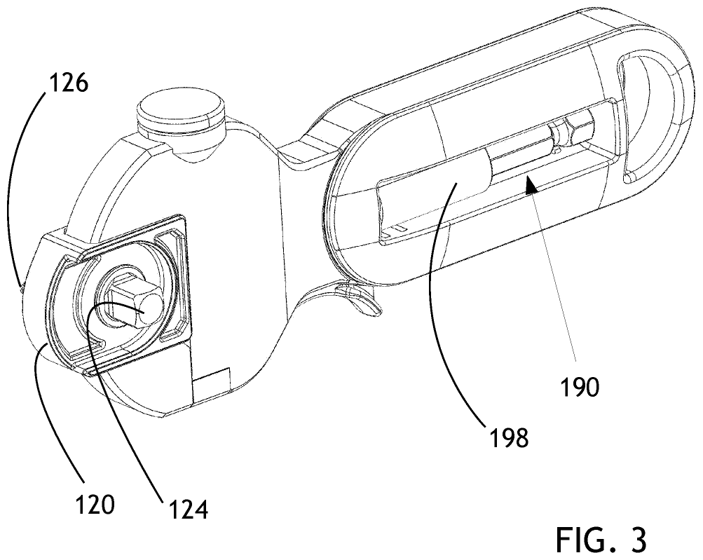

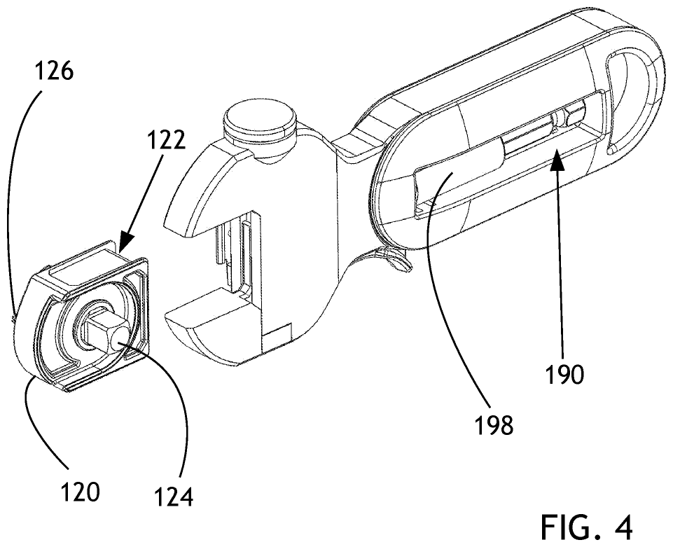

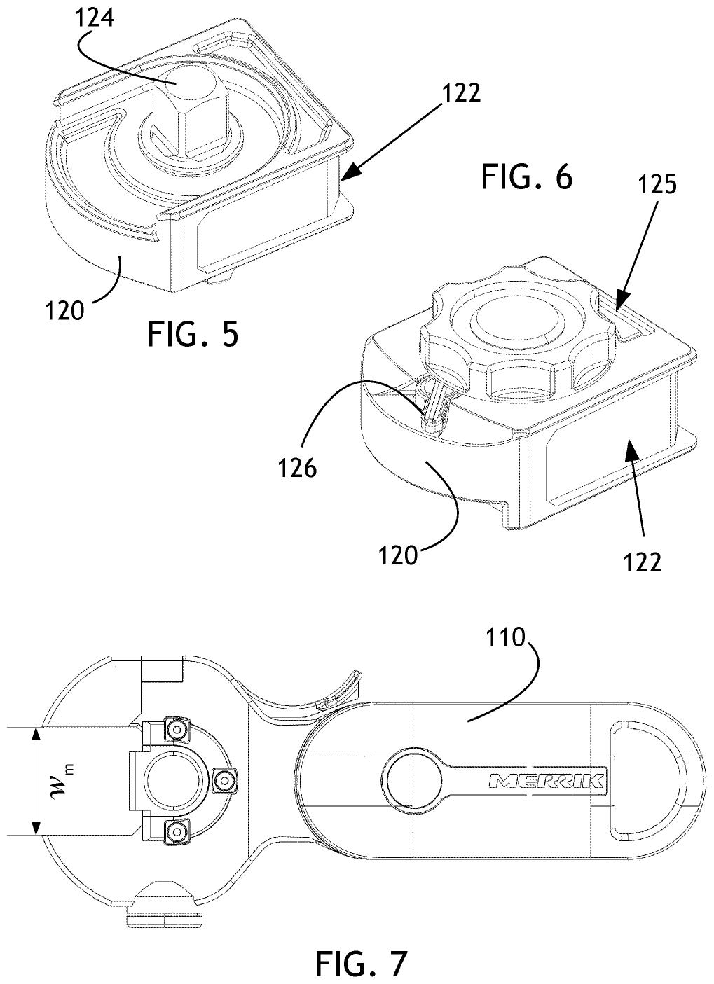

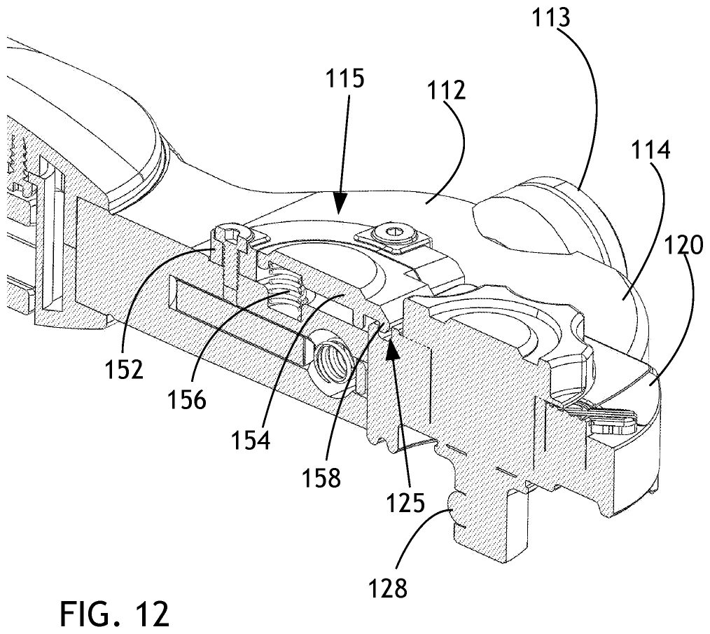

As seen in FIGS. 3-6, the attachment module (120) features a socket wrench mount (124) at what would be a right angle to the wrench (110). As with most socket wrenches, a directional switch (126) to change the rotational direction of the socket mount (124) and a ball lock (128) (FIG. 12) to help secure sockets and other tools to the attachment module (120) are provided. For this socket wrench module (120), any ratcheting mechanism may be utilized. It is also important to understand that it is not the only type of module which may be utilized in the invention.

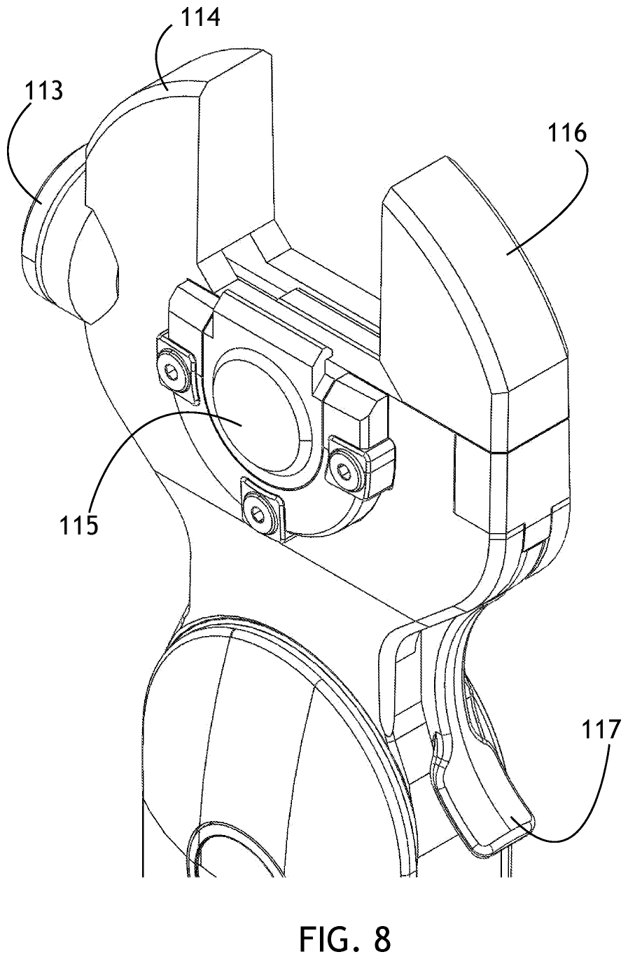

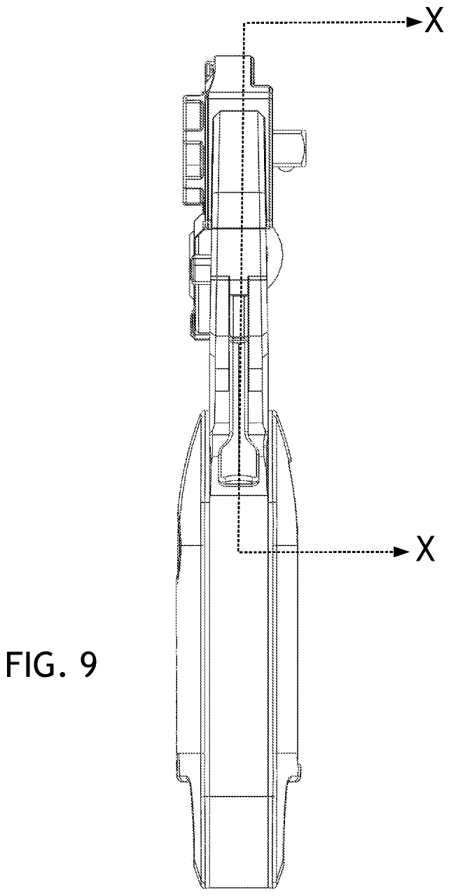

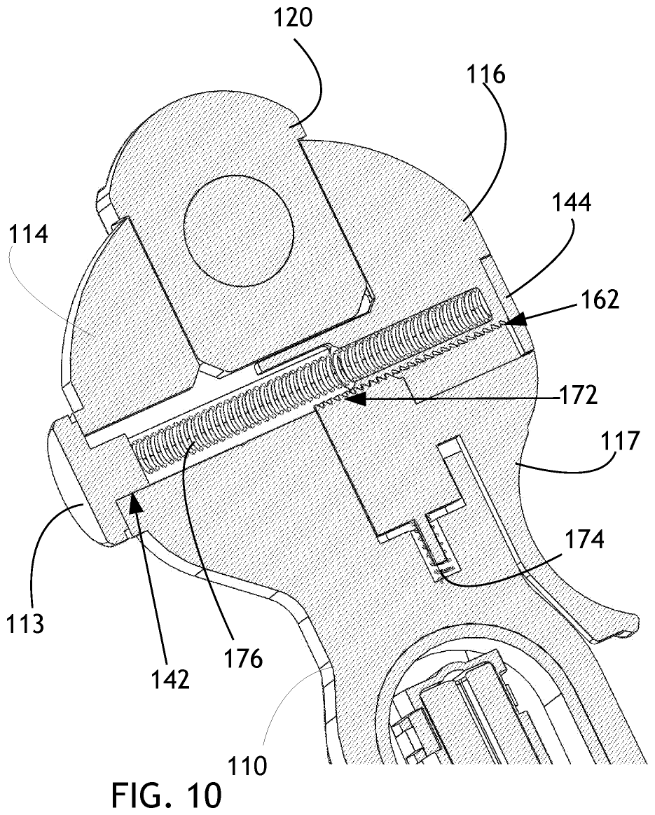

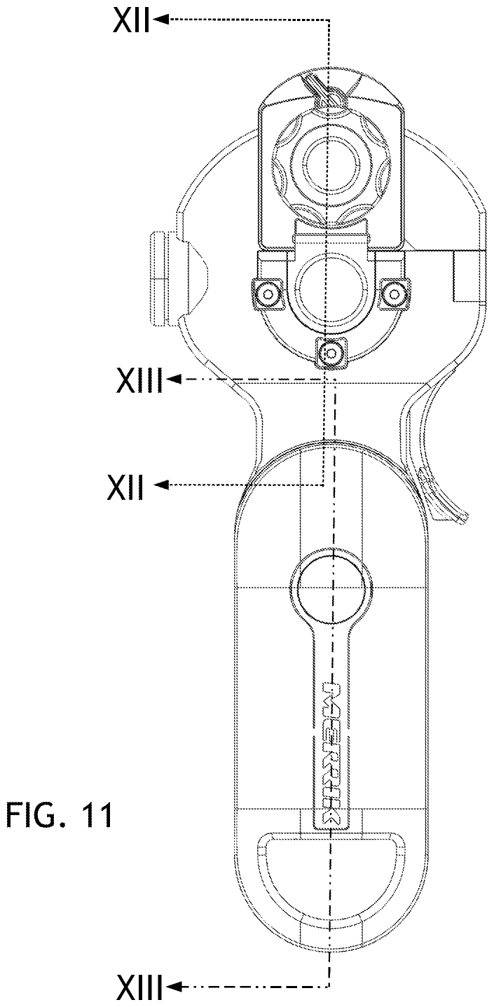

It should also be understood that the tool (110) may be used without the attachment module (120) or any other module, as its base form is an adjustable wrench (FIG. 7) with an adjustable jaw width. As shown in FIG. 8, mandible (116) slides along maxilla (114) and is anchored in a slot within the maxilla. Mandible (116) ratchets tighter, to smaller widths, and is released by trigger (117). The internal mechanism is detailed in FIG. 10. Mandible (116) has a toothed lower edge (162) which interfaces with a toothed upper edge (172) of the trigger (117). As such, the mandible (116) may be merely pushed towards the maxilla (114) in order to achieve a custom fit for a given nut or another object. Trigger (117) is spring biased (174) to engage the mandible (116) and hold it in place at that position. When this spring bias is countered and the trigger (117) disengages from the mandible (116), a mandibular spring (176) forces the mandible (116) outward to is maximal position, stopped by wall (144). In this way, the use of a module is more easily achieved as depressing the trigger (117) automatically creates a default width for accommodating a module (120). Trigger (117) is located on the handle of the tool (110) rather than the head (112). This positioning allows for the trigger (117) to only be actuated when the user desires while allowing for a more stable hold and easier intentional actuation. The ratcheting surfaces (162, 172) are also entirely contained within the head of the tool (112), preventing exposure to and possible damage from the environment.

Module latch (115) secures the attachment module (120) to the head of the tool (112), shown in FIGS. 8 and 12. Module button (154) resides within a housing (152) on the head of the tool (112). It is spring biased (156) and has an off-center pivot so that tooth (158) will interface with the slot (125) provided on the attachment module (120). Tooth (158) and the outer wall of the module (120) are ideally co-operatively slanted so that simply pushing the module in place will overcome the spring bias (156) and move the module button (154) to allow for attachment. Housing (152) provides containment of the module latch (115) and aids in location and protects the mechanism. While not as cost effective, a magnetic securement system could be developed to hold the module (120) in place.

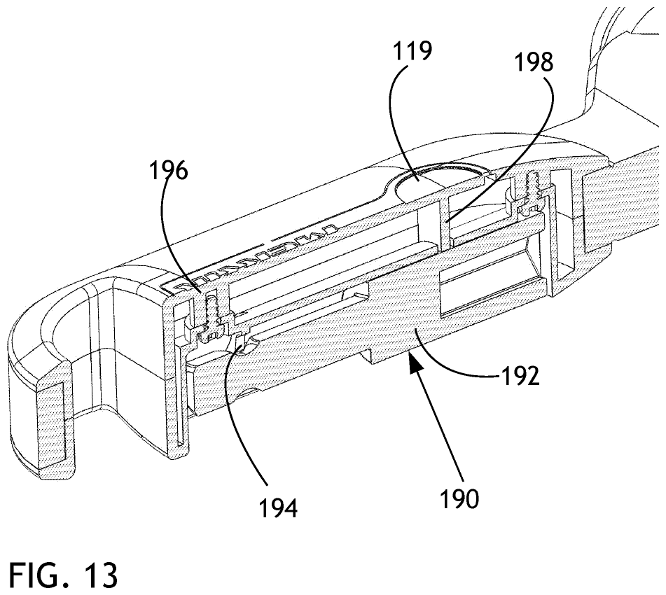

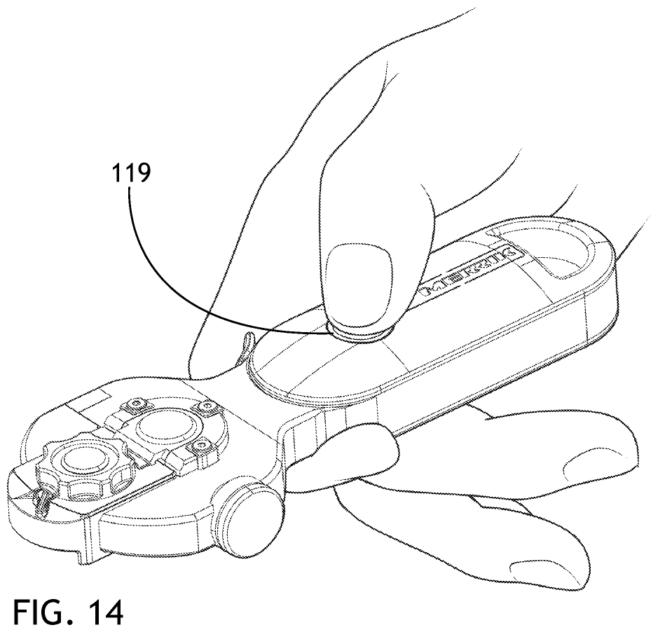

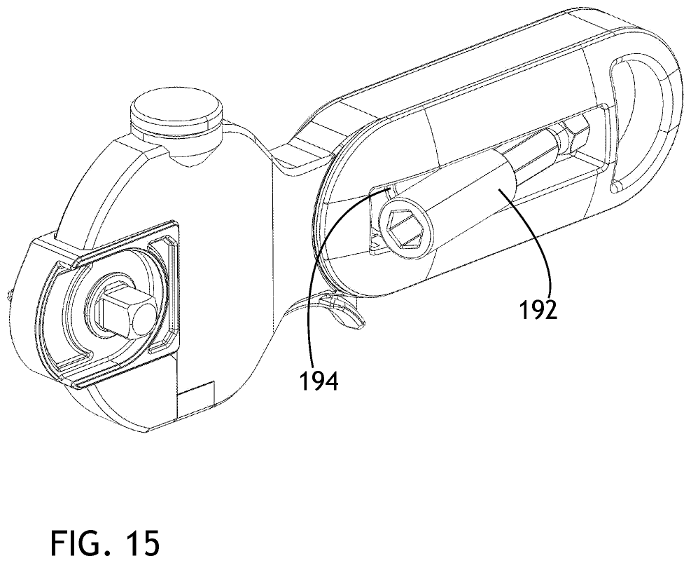

A chamber (190) for storage of a tool bit (192) may be fashioned in the handle of the tool (110), as is shown in FIGS. 3, 4, and 13. The chamber (190) features anchoring fingers (194) to hold the tool bit in place. When the tool bit (192) is required, release button (119) is pushed (FIG. 14). The button is anchored at an extreme end of the name plate, where it has its fulcrum (196). A spike (198) is located immediately beneath the button and has passage into the chamber (190) behind the tool bit (192). This action then overcomes the friction fit of the anchoring fingers (194) and releases the tool bit (192) (FIG. 15). It is preferred that the name plate be made of an elastomeric and flexible material to withstand the pushing of the release button repeatedly.

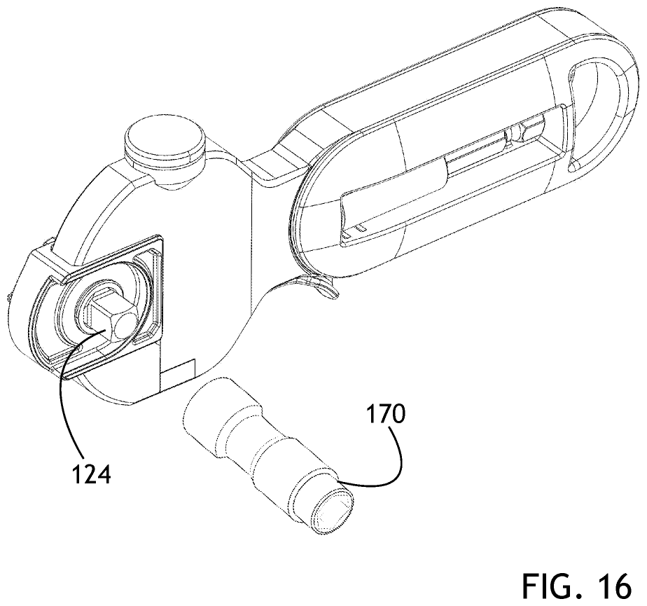

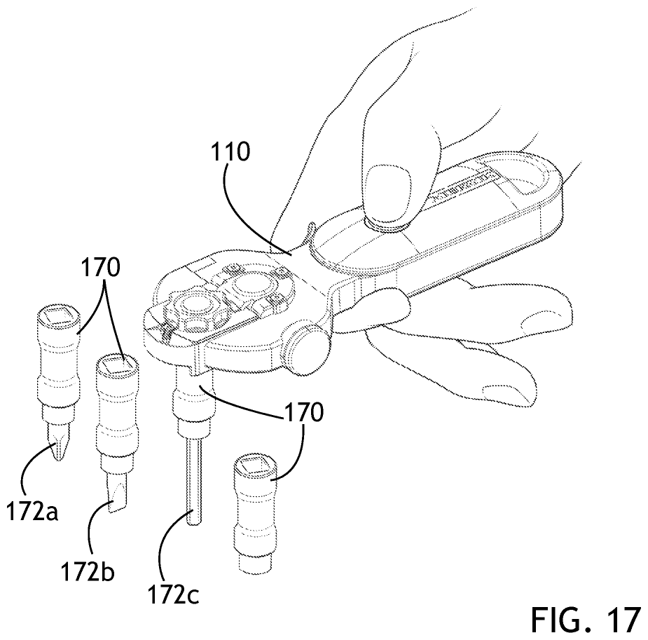

The depicted socket wrench module (120) may be made to ratchet or not. The socket mount (124) may also be made to fit any size of socket heads, including ¼ inch, ⅜ inch, or ½ inch sizes. It may also accommodate a bit adapter (170) (FIG. 16). The use of a bit adapter allows for the use of screwdriver and other tool bits, such as those shown in FIG. 17. One end of the adapter fits over the socket mount (124) while the other provides support for the bit (172a, 172b, 172c). Many bit types and forms may be conceived and utilized with the tool, so the depicted bits should not limit the interpretation of the invention to the depicted examples. Likewise, modules may be made that serve as their own tools, such as a bottle opener, or that allow for the attachment of other tools or even the direct attachment of tool bits.

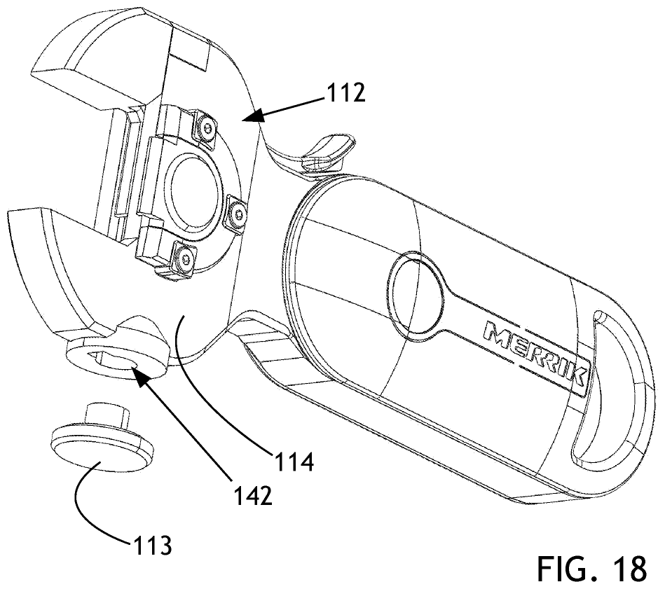

The tool may also be utilized as a hammer. As shown in FIG. 18, a hammer module (113) is made to fit in hammer socket (142). The depicted interface is a friction fit, but other attachment interfaces, such as a threaded fit, may also be utilized. The hammer socket (132) should reside in the maxilla (114). As can be seen in FIGS. 10 and 12, this maxilla jaw (114) is to be ruggedly made and form the bulk of the tool head (112). While not shown, it should be readily understood that different types of hammer head modules may be manufactured, including rubber or ball heads.

### INDUSTRIAL APPLICABILITY

The present invention has industrial applicability in that it may be manufactured and is a tool used in industry. Although the present invention has been described with reference to preferred embodiments, numerous modifications and variations can be made and still the result will come within the scope of the invention. No limitation with respect to the specific embodiments disclosed herein is intended or should be inferred.

1. A modular tool comprising:
a wrench having a head with two jaws, a maxilla fixedly related to the head and a mandible slidingly movable in relation to the maxilla between a minimal separation, where the jaws touch, and a maximal separation, where the jaws are as far apart from each other as possible; and,
an adapter module shaped and sized to fit within the maximal separation of the mandible and maxilla and be held in place by said jaws while the jaws are in said maximal separation;
the wrench being usable as such with the adapter module removed therefrom.

2. The modular tool of claim 1, further comprising a ratchet mechanism interacting with the mandible and controlling the relation between the mandible and maxilla, the ratchet mechanism being spring-biased, allowing the mandible to be released and rapidly separate said mandible and maxilla to the maximal separation while preventing separation of the jaws when the ratchet mechanism is engaged with the mandible.

3. The modular tool of claim 2, the spring-biased ratchet mechanism being released by a trigger located on a handle of the modular tool.

4. The modular tool of claim 2, wherein all ratcheting surfaces are contained within the head of the modular tool.

5. The modular tool of claim 1, the adapter module having a trench about at least one side shaped in a manner to key into the mandible and the maxilla.

6. The modular tool of claim 1, further comprising a latch securing the adapter module within the jaws.

7. The modular tool of claim 6, the latch further comprising:
a slot located on the module; and
a pivotably mounted button having a tooth on one edge and a spring bias opposite the tooth;
the tooth interfacing with the slot on the module.

8. The modular tool of claim 1, a handle of the tool further comprising a chamber to store an additional tool component.

9. The modular tool of claim 1, the adapter module having a socket wrench head.

10. A modular tool comprising:
a wrench further comprising a handle with an internal chamber to store an additional tool component and a head with two jaws, specifically a maxilla fixedly related to the head and a mandible slidingly movable in-line with the maxilla between a minimal separation and a set separation, where the jaws are a predetermined distance apart from each other;
an adapter module shaped and sized to fit within the predetermined distance of the mandible and maxilla and be held in place by said jaws while the jaws are in said set separation;
a biasing spring interacting with the mandible; and
a spring-biased trigger releasable ratchet mechanism, in-line with the mandible and maxilla and further comprising a trigger structure and co-acting ratchet surfaces on the mandible and the trigger structure;
wherein the ratchet mechanism allows for the jaws to be positioned more closely together and prevents their separation until the trigger structure is actuated and releases the co-acting ratchet surfaces, allowing the biasing spring to force the mandible apart from the maxilla to the set separation.
